(19) United States
(12) Patent Application Publication
(10) Pub. No.: US 2014/0178094 A1
(43) Pub. Date: Jun. 26, 2014

(54) DEVELOPING UNIT, PROCESS CARTRIDGE AND IMAGE FORMING APPARATUS

(71) Applicant: CANON KABUSHIKI KAISHA, Tokyo (JP)

(72) Inventors: Ryosuke Kanai, Kawasaki-shi (JP); Satoshi Sunahara, Kawasaki-shi (JP); Yasunari Watanabe, Suntou-gun (JP)

(21) Appl. No.: 14/109,765

(22) Filed: Dec. 17, 2013

(30) Foreign Application Priority Data
Dec. 20, 2012 (JP) 2012-278517

(51) Int. Cl. G03G 15/09

(52) U.S. Cl. CPC G03G 15/0942
USPC 399/104

(57) ABSTRACT

Provided is a developing unit including: a developer container configured to contain a magnetic developer; a developer carrier provided with an elastic portion, configured to bear the magnetic developer in the elastic portion and to cause the elastic portion to be in contact with an image bearing member to develop a latent image formed on the image bearing member; and a magnetic sealing member disposed, on a plane which perpendicularly crosses an axial line of the developer carrier, at a predetermined distance from a longitudinal direction end portion of the developer carrier and configured to regulate leakage of the developer from between the developer container and the developer carrier, wherein, in a longitudinal direction of the developer carrier, an end portion of the elastic portion is disposed between an inner end portion and an outer end portion of the magnetic sealing member.

### BACKGROUND OF THE INVENTION

1. Field of the Invention

The present invention relates to a developing unit and a process cartridge of an electrophotographic image forming apparatus, and relates to an image forming apparatus.

2. Description of the Related Art

As electrophotographic developing units, various types of contact developing units which develop images while being in contact with a photosensitive member have been proposed. In a contact developing system, an elastic material, such as rubber, is typically used as a material of a surface of a developer carrier because the developer carrier rotates and develops images in contact with a surface of the photosensitive member. A rubber layer forming the surface of the developer carrier is a single layer or a multilayer. In the case of a nonmagnetic one-component contact developing system, a developer supplying member is typically used to supply toner which is a developer to the developer carrier. Since the developer supplying member and the developer carrier rotate in the opposite directions, frictional force therebetween is large. Therefore, an adhesive layer is disposed between a base and the rubber layer to avoid twisting of the base and a rubber portion.

An end portion sealing member is provided at an end portion of a development opening to prevent leakage of toner from a gap between an end portion of the developer carrier and an opening through which the toner is supplied to the developer carrier from a developer container which contains the toner. As end portion sealing members, a contact elastic sealing member and a non-contact magnetic sealing member, which is disclosed in Japanese Patent No. 4018210, have been proposed.

The elastic sealing member is made of, for example, a fiber material, such as wool felt, and foam, such as sponge rubber, and is in contact with the developer carrier to seal the toner.

The magnetic sealing member is a sealing member in which the north pole and the south pole are disposed along the circumferential direction of the developer carrier. The magnetic sealing member is a member to absorb magnetic toner to prevent the toner from leaking out of the developing unit. This magnetic sealing member is disposed in a non-contact manner at a predetermined distance from the developer carrier.

In Japanese Patent Laid-Open No. 2001-215791, an arrangement of a rubber portion of a multilayered developer carrier and a contact elastic sealing member in an axial direction (hereafter, a longitudinal direction) of the developer carrier is proposed. In the disclosed technique, if a longitudinal direction end portion of the rubber layer is made to rub against the contact elastic sealing member, the rubber layer is peeled off due to frictional force; therefore, the longitudinal direction end portion of the rubber layer is disposed outside a longitudinal direction outer end portion of the elastic sealing member.

However, if the longitudinal direction end portion of the rubber layer of the developer carrier of the contact developing unit is disposed outside the longitudinal direction outer end portion of the elastic sealing member, wear of the photoconductive drum became large although peeling of the rubber layer can be prevented. Therefore, it is difficult to prolong the lifetime of the photoconductive drum.

This is because, since a very little amount of toner exists between the end portion of the rubber layer of the developer carrier and the end portion sealing member, a lubrication effect produced by the toner between the photoconductive drum and the rubber layer is smaller than in an area inside the end portion sealing member in which the toner always exists and, therefore, frictional force becomes larger. A surface of the photoconductive drum is worn after a long period of use. Wear is larger when frictional force is large. As the photoconductive drum is worn after a long period of use, an excessively large amount of charging current may flow at the worn portion and leakage may occur. Therefore, a user is encouraged to replace the photoconductive drum when the thickness of a layer of the photoconductive drum reaches a predetermined threshold.

### SUMMARY OF THE INVENTION

An object of a configuration disclosed in the present application is to successfully seal toner and reduce wear of an image bearing member while reducing peeling of an elastic portion of a developer carrier.

A typical configuration of a developing unit for solving the above-described problems is a developing unit including: a developer container configured to contain a magnetic developer; a developer carrier provided with an elastic portion, configured to bear the magnetic developer in the elastic portion and to cause the elastic portion to be in contact with an image bearing member to develop a latent image formed on the image bearing member; and a magnetic sealing member disposed, on a plane which perpendicularly crosses an axial line of the developer carrier, at a predetermined distance from a longitudinal direction end portion of the developer carrier and configured to regulate leakage of the developer from between the developer container and the developer carrier, wherein, in a longitudinal direction of the developer carrier, an end portion of the elastic portion is disposed between an inner end portion and an outer end portion of the magnetic sealing member.

A typical configuration of a process cartridge is a process cartridge which is removably attached to a main body of an image forming apparatus, including: an image bearing member; a developer container configured to contain a magnetic developer; a developer carrier provided with an elastic portion, configured to bear the magnetic developer in the elastic portion and to cause the elastic portion to be in contact with an image bearing member to develop a latent image formed on the image bearing member; and a magnetic sealing member disposed, on a plane which perpendicularly crosses an axial line of the developer carrier, at a predetermined distance from a longitudinal direction end portion of the developer carrier and configured to regulate leakage of the developer from between the developer container and the developer carrier, wherein, in a longitudinal direction of the developer carrier, an end portion of the elastic portion is disposed between an inner end portion and an outer end portion of the magnetic sealing member.

A typical configuration of an image forming apparatus is an image forming apparatus for forming an image on a recording medium, including: an image bearing member; a developer container configured to contain a magnetic developer; a developer carrier provided with an elastic portion, configured to bear the magnetic developer in the elastic portion and to cause the elastic portion to be in contact with an image bearing member to develop a latent image formed on the image bearing member; and a magnetic sealing member disposed, on a plane which perpendicularly crosses an axial line of the developer carrier, at a predetermined distance from a longitudinal direction end portion of the developer carrier and configured to regulate leakage of the developer from between the developer container and the developer carrier, wherein, in a longitudinal direction of the developer carrier, an end portion of the elastic portion is disposed between an inner end portion and an outer end portion of the magnetic sealing member.

Further features of the present invention will become apparent from the following description of exemplary embodiments with reference to the attached drawings.

### BRIEF DESCRIPTION OF THE DRAWINGS

FIGS. 1A and 1B are front structural diagrams of a developing unit according to a first embodiment.

FIG. 2 is a schematic cross-sectional view of a process cartridge according to the first embodiment.

FIG. 3 is a diagram illustrating a wear amount of a drum in a longitudinal direction.

FIG. 4 is a schematic cross-sectional view of a developing unit according to a fourth embodiment.

FIG. 5 is a cross-sectional view of a developer carrier.

FIG. 6 is a schematic configuration diagram of an image forming apparatus.

### DESCRIPTION OF THE EMBODIMENTS

Hereinafter, preferred embodiments of the present invention will be described in detail with reference to the drawings.

### EXAMPLES 1 to 3

First to third embodiments (Examples 1 to 3) of the present invention will be described.

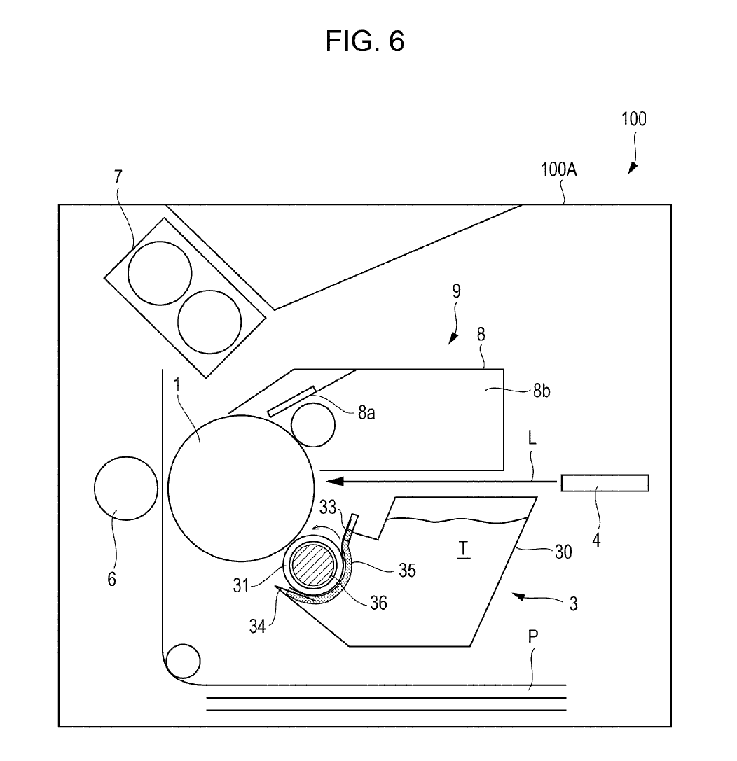

FIG. 6 is a schematic configuration diagram of an image forming apparatus (an image recording apparatus) 100. This image forming apparatus is a laser printer in which an electrophotographic process is employed. Although details will be described later, the image forming apparatus 100 of the present embodiment employs a magnetic contact developing system as a developing system thereof.

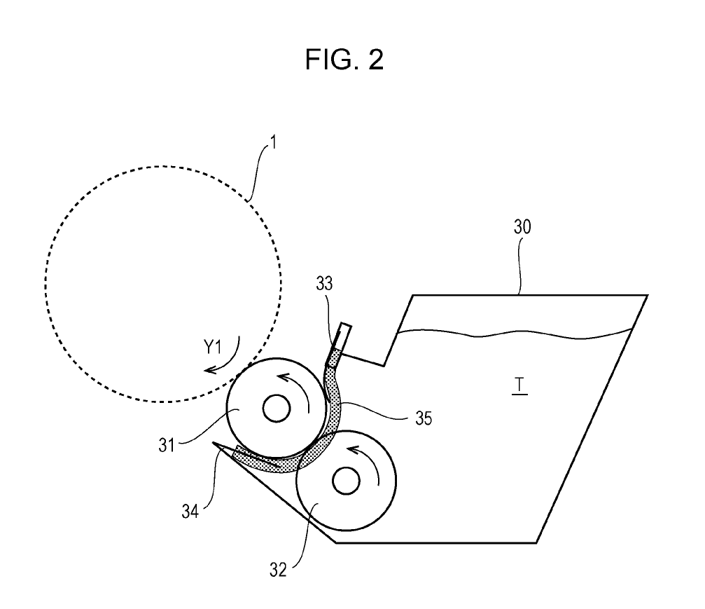

The reference numeral 1 denotes an image bearing member which is, in this Example, a φ24-mm rotating drum type negative OPC photosensitive member (a negative photosensitive member; hereafter, referred to as a photoconductive drum). This photoconductive drum 1 is driven to rotate in the clockwise direction indicated by an arrow Y1 in FIG. 2 at a constant peripheral speed of 85 mm/sec (i.e., a process speed PS; a printing speed).

The reference numeral 2 denotes a charging roller provided as a charging unit (a charging device) of the photoconductive drum 1. This charging roller 2 is a conductive elastic roller and, in this Example, this charging roller 2 rotates following the rotation of the photoconductive drum 1.

A direct current voltage of −1300 V is applied to the charging roller 2 as a charging bias to achieve contact charging by which the surface of the photoconductive drum 1 is uniformly charged to a charged potential (a dark-area potential) of −700 V.

The reference numeral 4 denotes a laser beam scanner (an exposure device) which includes a laser diode and a polygon mirror. The laser power is adjusted such that the potential of the surface of the photoconductive drum 1 becomes −150 V when the entire surface which is to be uniformly charged is exposed to the laser light.

By this scanning exposure L, an electrostatic latent image corresponding to target image information is formed on the surface of the photoconductive drum 1 which is rotating.

The reference numeral 3 denotes a developing unit (a developing device). Toner T is a developer used for developing the latent image and carries a certain electric charge by triboelectric charging. Here, a developing bias voltage is applied between a developer carrier (a developing roller) 31 and the photoconductive drum 1 by an unillustrated development bias application power supply.

The reference numeral 6 denotes is a transfer roller provided as a contact transfer means, which is pressed against the photoconductive drum 1 with predetermined pressure. A transfer material P as a recording material (a recording medium) is fed to this transfer portion from an unillustrated paper feeding unit at predetermined timings and a predetermined transfer bias voltage is applied to the transfer roller 6. With this configuration, a toner image (a developer image) on the photoconductive drum 1 side is transferred sequentially to a surface of the transfer material P which has been fed to a transfer nip portion.

The reference numeral 7 denotes a fixing device which employs, for example, a heat fixing system. The transfer material P to which the toner image is transferred in the transfer portion is separated from the surface of the rotating photoconductive drum 1 and introduced into this fixing device 7 where the toner image is fixed. The transfer material P is then discharged out of the apparatus as an image formed matter (a print copy).

The reference numeral 8 denotes a photosensitive drum cleaning unit (a drum cleaner) which scrapes transfer residual toner on the photoconductive drum 1 with a cleaning blade 8a and collects the toner into a waste toner container 8b.

Then, the photoconductive drum 1 is again charged by the charging device (the charging roller 2) and is repeatedly used for image formation.

The reference numeral 9 denotes a process cartridge in which the photoconductive drum 1, the charging roller 2, the developing unit 3 and the drum cleaner 8 are integrated with one another. The process cartridge is removably attached to a main body 100A of the image forming apparatus 100.

FIG. 2 is a cross-sectional view of the developing unit 3 and the photoconductive drum 1 according to the first embodiment. The developing unit 3 employs a contact developing system which develops images while being in contact with the photoconductive drum 1. The photoconductive drum 1 is an image bearing member on which a latent image (an electrostatic latent image) is formed.

Toner T which is a magnetic developer is contained in a developer container 30. The Toner T is supplied to a developer carrier 31 by a developer supplying member 32. The developer carrier 31 is a member which bears the developer (the toner) and supplies the toner to the latent image on the photoconductive drum 1 so that the latent image is developed as a developer image (a toner image).

A layer thickness regulating member 33 regulates the layer thickness (an amount) of the toner T supplied to the developer carrier 31 by the developer supplying member 32 to the desired thickness. Then, the toner T is charged and supplied to a contact portion at which the developer carrier 31 is brought into contact with the photoconductive drum 1. At the contact portion at which the developer carrier 31 is brought into contact with the photoconductive drum 1, the electrostatic latent image on the surface of the photoconductive drum 1 is developed with the toner T. A peripheral surface of the developer carrier 31 in the this Example rotates 40% faster than a peripheral surface of the photoconductive drum 1 does in the forward direction with respect to the photoconductive drum 1 (the direction of the arrow in FIG. 2).

A magnetic sealing member 35 is disposed at a position facing a longitudinal direction end portion of the developer carrier 31 in a non-contact manner with a predetermined space (gap) formed therebetween. That is, when the developer carrier 31 and the magnetic sealing member 35 are seen on a plane which perpendicularly crosses an axial line of the developer carrier 31 (i.e., a cross section illustrated in FIG. 2), a gap is provided between the developer carrier 31 and the magnetic sealing member 35.

In the magnetic sealing member 35, the north pole and the south pole are disposed along the circumferential direction of the developer carrier 31. That is, the magnetic sealing member 35 is magnet magnetized at a plurality of electrodes. The magnetic sealing member 35 absorbs the toner T and seals the gap between the developer carrier 31 and the magnetic sealing member 35, thereby reducing (regulating) leakage of the toner T out of the developer container 30 from developer carrier 31 in the axial direction (hereafter, referred to as the longitudinal direction).

A blowout prevention sheet 34, which is disposed in contact with the developer carrier 31, causes the toner T which is not used for the development to pass through and, at the same time, prevents leakage of the toner T in the developer container 30 from a lower portion of the developer carrier 31.

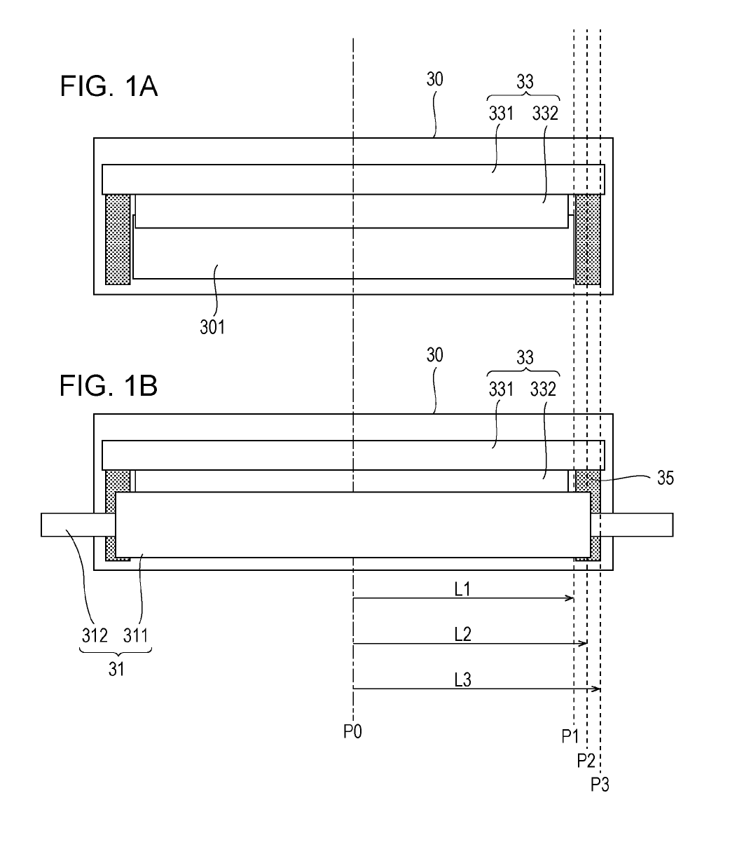

FIGS. 1A and 1B are front structural diagrams of the developing unit according to the first embodiment. FIG. 1A is a schematic diagram in which the developer carrier 31 and the developer supplying member 32 are not illustrated; and FIG. 1B is a schematic diagram in which the developer carrier 31 is added to FIG. 1A.

The toner T is supplied to the developer carrier 31 via the developer supplying member 32 through a development opening 301. A dash-dot line in the diagram indicates a center line of the development opening 301 along the longitudinal direction. The central position of the development opening 301 along the longitudinal direction is set to P0.

The layer thickness regulating member 33 is constituted by a base 331 which is made of metal and a blade portion 332 made of, for example, urethane rubber. A longitudinal direction end portion of the blade portion 332 is disposed slightly inside an inner end portion of the magnetic sealing member 35. This is because, since the magnetic sealing member 35 and the blade portion 332 overlap each other in the cross-sectional direction, if the magnetic sealing member 35 and the blade portion 332 overlap each other in the longitudinal direction, blade pressure at the end portion become excessively high and it is therefore not possible to make the toner layer thickness uniform along the longitudinal direction. For this reason, the magnetic sealing member 35 and the blade portion 332 are not made to overlap each other in the longitudinal direction in consideration of the manufacturing tolerances or assembling tolerances. In this Example, the length of the magnetic sealing member 35 from the position of the inner end portion to the center P0 of the development opening 301 is set to 110 mm and the length of the layer thickness regulating member 33 from a longitudinal direction end portion to the center P0 of the development opening 301 is set to 109.5 mm.

The toner T in the gap between the magnetic sealing member 35 and the blade portion 332 is sealed by a sealing member consisting of, for example, sponge.

In consideration of the manufacturing tolerances or assembling tolerances, the position of a longitudinal direction end portion of the developer supplying member 32 is set such that the length from the longitudinal direction end portion of the developer supplying member 32 to the center P0 of the development opening 301 is set to 109 mm, whereby the developer supplying member 32 does not interfere with the magnetic sealing member 35 or the developer container 30 in the longitudinal direction.

The developer carrier 31 is constituted by a base 312 which is made of metal and a rubber portion (an elastic portion) 311 which is made of rubber. Further, the rubber portion 311 has a two-layer configuration which consists of a base layer and a surface layer from a base side. Functions required for the developer carrier 31 are to provide a necessary developing nip and to have sufficient recoverability to compressive force against contact. In addition to these, various functions are considered, including that the toner on the developing roller obtains desired charging polarity and a desired charge amount and that a surface of the developer carrier has excellent releasability with toner T and thus the toner filming does not occur on the surface.

For this reason, the developer carrier 31 has a two-layer configuration to separate the function required near the developer carrier surface and the function inside the developer carrier. The base layer is made of an elastic member, such as silicon rubber, formed by using molding or extrusion molding. The surface layer is made of an elastic member, such as urethane rubber, and is formed on the base layer by, for example, dip coating and roll coating. The outer diameter of the developer carrier 31 of this Example is 10 mm, the diameter of the metal base 312 is 6 mm, and the thickness of the rubber portion 311 is 2 mm. Although the rubber portion has a two-layer configuration and the rubber thickness is 2 mm in this Example, this configuration is not restrictive; any configuration may be employed as long as the rubber portion may be in stable contact with the photoconductive drum 1 and an electrostatic latent image may be developed. In the developer carrier 31 of this Example, the base 312 and the rubber portion 311 are fixed by an adhesion. The toner (the developer) is born by this rubber portion 311. The developer carrier 31 brings the rubber portion 311 into contact with the photoconductive drum 1 to develop the latent image formed on the photoconductive drum 1.

Subsequently, a relationship between the magnetic sealing member 35 and the rubber portion 311 of the developer carrier 31 along the longitudinal direction will be described.

A position of the rubber portion 311 of the developer carrier 31, especially a position of a longitudinal direction end portion of the surface layer is set to P2. A position of the inner end portion of the magnetic sealing member 35 is set to P1. A position of an outer end portion of the magnetic sealing member 35 is set to P3. Lengths from the center P0 of the development opening 301 to P1, P2 and P3 are set to L1, L2 and L3, respectively.

Here, since the relationship among L1, L2 and L3 is set to L1<L2≦L3, it is possible to successfully keep the sealing of the toner by the magnetic sealing member 35 and to reduce wear of the drum while reducing peeling of the rubber portion 311 of the developer carrier 31 from the base 312.

Hereinafter, the Example will be described in detail with reference to Comparative Examples. In this Example, L1 is set to 110 mm and L3 is set to 114 mm. Experiment 1

Images are formed on 5000 sheets by each of developing units with varied lengths of L2 and toner leakage, peeling of the rubber portion and the number of image forming sheets to the lifetime of the photoconductive drum are examined. The results are shown in the following table. As the photoconductive drum 1, a laminated OPC drum which is 24 mm in diameter and includes, on a surface thereof, a 12 μm-thick charge transport layer is used.

The magnetic sealing member 35 has an arc which is larger by 0.1 mm than the outer diameter of the rubber portion 311 of the developer carrier 31.

The toner leakage is checked in the following manner: the main body of the image forming apparatus and the developing unit after images are formed on 5000 sheets are examined. ∘ indicates no toner leakage occurred and x indicates toner leakage has occurred. Peeling of the rubber portion is checked in the following manner: the developing unit after images are formed on 5000 sheets is examined. ∘ indicates no rubber peeling occurred and x indicates rubber peeling has occurred.

Regarding the drum lifetime, when the thickness of the charge transport layer becomes 1 μm even partially, it is determined that leakage may occur, and thus the number of sheets on which images have been formed when the thickness of the charge transport layer reaches 1 μm is recorded. In the table, 1000 sheets are shown as 1k sheets.

TABLE 1

| | COMP. | COMP. | | | | COMP. | COMP. |
|---|---|---|---|---|---|---|---|
| | EXAMPLE 1 | EXAMPLE 2 | EXAMPLE 1 | EXAMPLE 2 | EXAMPLE 3 | EXAMPLE 3 | EXAMPLE 4 |
| L2 (mm) | 108 | 110 | 111 | 112 | 114 | 116 | 118 |
| TONER LEAKAGE | x | x | ∘ | ∘ | ∘ | ∘ | ∘ |
| PEELING OF | ∘ | ∘ | ∘ | ∘ | ∘ | ∘ | ∘ |
| RUBBER PORTION | | | | | | | |
| LIFETIME OF | 12k | 12k | 11k | 11k | 10k | 7k | 6.5k |
| DRUM (SHEETS) | | | | | | | |

Toner leakage will be described first.

Toner leakage occurs in Comparative Example 1. This is because, since an end portion of the rubber portion 311 is positioned inside the inner end portion of the magnetic sealing member 35, there is a large gap among the magnetic sealing member 35, the rubber portion 311 of the developer carrier 31 and the base 312 of the developer carrier 31. Further, there is also a large gap between the developer carrier 31 and the blowout prevention sheet 34.

Toner leakage occurs in Comparative Example 2. This is because the rubber portion 311 and the magnetic sealing member 35 do not overlap in the longitudinal direction and, although a small gap is formed between the rubber portion 311 and the magnetic sealing member 35, since only a small gap exists partially in the longitudinal direction, the gap is not stabilized when the developer carrier 31 is rotated, whereby leakage of the toner T occurs.

No toner leakage occurs in Examples 1 to 3 and Comparative Examples 3 and 4. This is because the rubber portion 311 and the magnetic sealing member 35 sufficiently overlap in the longitudinal direction, the small gap is stable even when the developer carrier 31 rotates. The toner T adhered to the magnetic sealing member 35 fills the small gap to prevent leakage of other toner and the toner T adhering to the magnetic sealing member 35 does not leak out.

From the results described above, by setting to L1<L2, a sufficient toner sealing effect can be obtained.

Peeling of the rubber portion will be described.

In all the cases of Experiment 1, peeling of the rubber portion 311 has not occurred. This is because the non-contact magnetic sealing member 35 is used as the end portion sealing member and thus no frictional force is produced between the developer carrier 31 and the magnetic sealing member 35. If a contact elastic sealing member is used, when the rubber end portion of the developer carrier is disposed between the inner end portion and the outer end portion of the contact elastic sealing member, a weaker rubber end portion is made to rub against the contact sealing member. Therefore, peeling of the rubber portion may occur.

Therefore, peeling of the rubber portion 311 can be prevented by using the magnetic sealing member 35 as the end portion sealing member.

Next, wear of the photoconductive drum will be described. In the case of the contact developing unit, development is performed while the photoconductive drum 1 and the developer carrier 31 are in contact with each other and are rotating under predetermined pressure. Therefore, the surface of the photoconductive drum 1 is gradually worn as it is used. As the frictional force between the photoconductive drum 1 and the developer carrier 31 is large, the wear amount of the photoconductive drum 1 becomes large.

As the photoconductive drum 1 becomes worn, an excessively large amount of charging current may flow at the worn portion and leakage may occur. If there is a waste toner container 8b for collecting toner which remained on the photoconductive drum 1, the waste toner may leak out from a location at which the wear amount is large along the longitudinal direction. Therefore, it is necessary to reduce the wear amount of the photoconductive drum 1 or a difference in the wear amount of the photoconductive drum 1 along the longitudinal direction.

The results of Experiment 1 show that the drum lifetime is shortened significantly in Comparative Examples 3 and 4 in which L3<L2. This is because, if the end portion of the rubber portion 311 of the developer carrier 31 is disposed outside the longitudinal direction outer end portion of the magnetic sealing member 35, the photoconductive drum 1 and the rubber portion 311 of the developer carrier 31 rotate while rubbing against each other not via the toner T which has a lubrication effect and, therefore, the photoconductive drum 1 is worn in a greater amount at an area where the developer carrier 31 is in contact with the photoconductive drum 1 not via the toner T.

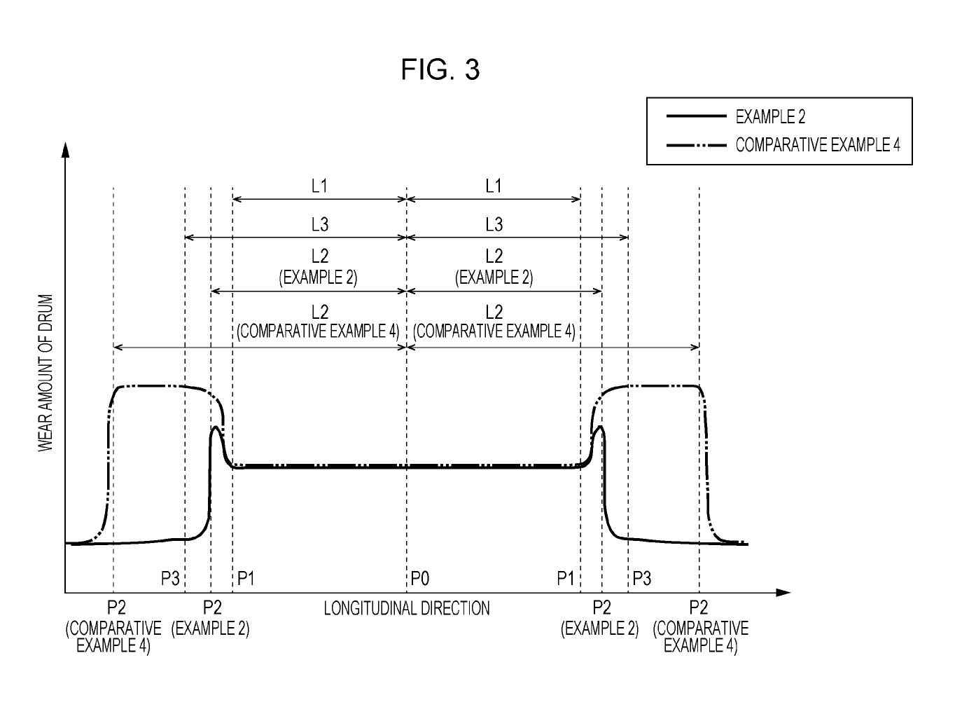

Hereinafter, this phenomenon will be described in detail with reference to FIG. 3.

FIG. 3 illustrates the results of the wear amount of the photoconductive drum 1 along the longitudinal direction of Example 2 and Comparative Example 4 of Experiment 1. In Comparative Example 4, the end portion of the rubber portion 311 of the developer carrier 31 is disposed outside the outer end portion of the magnetic sealing member 35. The solid line in the diagram indicates the result of Example 2 and the dash-dot-dot line indicates the result of Comparative Example 4. Both the results of Example 2 and Comparative Example 4 show the wear amount of the photoconductive drum 1 after images are formed on 5000 sheets.

As is understood from FIG. 3, the wear amount of the drum varies along the longitudinal direction. This is because, regarding an area in which the toner T is born by the developer carrier 31, the frictional force between the photoconductive drum 1 and the developer carrier 31 is smaller than that of the area in which the toner T is not born due to the lubrication effect produced by the toner T. Therefore, the wear amount of the drum is larger in the area in which the photoconductive drum 1 and developer carrier 31 are in contact with each other not via the toner T.

Regarding Example 2 and Comparative Example 4, there is no significant difference in the wear amount of the drum in an area inside P1. However, in Example 2, the wear amount of the drum has been able to be reduced in the area outside P1. This is because, since the longitudinal direction end portion P2 of the rubber portion 311 of the developer carrier 31 is disposed inside the outer end portion P3 of the magnetic sealing member 35, the area which is in contact with the photoconductive drum 1 without bearing the toner T has become smaller than in Comparative Example 4.

Regarding an area between P1 and P3 which is an area corresponding to the width of the magnetic sealing member 35, the wear amount of the drum is smaller in Example 2 than in Comparative Example 4. This is because the area in which the developer carrier 31 is in contact with the photoconductive drum 1 without bearing the toner T is smaller. In this area, since the toner T absorbed by the magnetic sealing member 35 adheres to the developer carrier 31 in a slight amount and have some lubrication effect as compared to an area outside P3, the wear amount of the drum becomes smaller than in the area outside P3.

Therefore, the wear of the drum can be reduced by setting L2≦L3.

From the results described above, by using the non-contact magnetic sealing member 35 as the end portion sealing member and by setting to L1<L2≦L3, it is possible to successfully seal the toner and to reduce wear of the drum while reducing peeling of the rubber portion 311 of the developer carrier 31.

As described above, in this Example, the magnetic developer (the magnetic toner) is employed as the developer and the magnetic sealing member is employed as the end portion sealing member. Further, in the longitudinal direction of the developer carrier 31, the end portion of the rubber portion 311 of the developer carrier 31 is disposed outside the inner end portion of the magnetic sealing member 35 and, at the same time, on or inside the outer end portion of the magnetic sealing member 35. That is, in the longitudinal direction of the developer carrier 31, the end portion of the rubber portion 311 is disposed between the inner end portion and the outer end portion of the magnetic sealing member 35.

With this configuration, a developing unit, a process cartridge in which this developing unit is used, and an image forming apparatus with which it is possible to successfully seal the toner and to reduce wear of the drum while reducing peeling of the rubber portion 311 of the developer carrier 31 can be provided. By reducing the wear of the drum, it is possible to provide a process cartridge and an image forming apparatus of prolonged lifetime in which the developing unit of this Example is used. Further, it is possible to provide a developing unit, a process cartridge and an image forming apparatus which are reduced in size in the longitudinal direction.

### EXAMPLE 4

A fourth embodiment (Example 4) of the present invention will be described. Configurations similar to those of Example 1 are denoted by similar reference numerals and description thereof will be omitted.

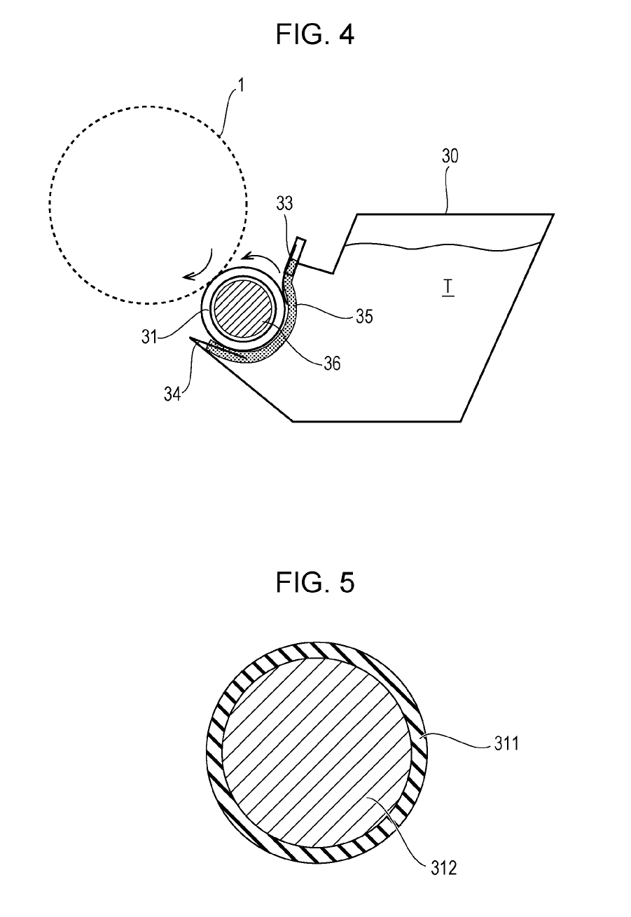

FIG. 4 is a cross-sectional view of a developing unit according to the fourth embodiment. The developing unit employs a contact developing system which develops images while being in contact with a photoconductive drum 1.

Toner T which is a magnetic developer is contained in a developer container 30. The toner T is supplied to the developer carrier 31 by a magnet roller 36 which is disposed in a developer carrier 31 in a fixed manner. The magnet roller 36 includes a plurality of magnetic pole portions along the circumferential direction. The magnet roller 36 adsorbs the toner T and supplies the same to the developer carrier 31.

A layer thickness regulating member 33 regulates the layer thickness of the toner T supplied to the developer carrier 31 by the magnet roller 36 to the desired thickness. Then, the toner T is charged and supplied to a contact portion at which the toner T is brought into contact with the photoconductive drum 1. At the contact portion with the photoconductive drum 1, the electrostatic latent image on the surface of the photoconductive drum 1 is developed with the toner T.

This magnetic sealing member 35 is disposed in a non-contact manner at a predetermined distance from a surface of the developer carrier 31. In the magnetic sealing member 35, the north pole and the south pole are magnetized at a plurality of electrodes along the circumferential direction of the developer carrier 31. The magnetic sealing member 35 absorbs the toner T and the toner T fills the gap between the developer carrier 31 and the magnetic sealing member 35, whereby leakage of the toner T outside the developer container 30 in the longitudinal direction is prevented.

A blowout prevention sheet 34, which is disposed in contact with the developer carrier 31, causes the toner T which is not used for the development to pass through and, at the same time, prevents leakage of the toner T in the developer container 30 from a lower portion of the developer carrier 31.

The developer carrier 31 is constituted by a hollow base 312 which is made of metal and a rubber portion 311 which is made of rubber. Further, the rubber portion 311 has a two-layer configuration which consists of a base layer and a surface layer from a base side. The base layer is made of an elastic member, such as silicon rubber, formed by using molding or extrusion molding. The surface layer is made of an elastic member, such as urethane rubber, and is formed on the base layer by, for example, dip coating and roll coating.

In this Example, no adhesive portion is provided between the base 312 of the developer carrier 31 and the rubber portion 311, and the base 312 of the developer carrier 31 and the rubber portion 311 are fixed by sticking force therebetween. The adhesive portion is originally provided to prevent twisting of the base 312 and the rubber portion 311. However, if the adhesive portion is provided, there is a problem that material cost therefor and a process to provide the adhesive portion are additionally required, whereby the cost increases. Then, in this Example, the base 312 and the rubber portion 311 are not made to adhere to each other and the tubular rubber portion 311 is made to stick (fixed) to the base 312 by elastic shrinking force.

The developer carrier 31 of this Example is manufactured in the following manner: a hollow rubber tube (the rubber portion 311) having an inner diameter slightly smaller than the outer diameter of the base 312 which is made of metal is manufactured by extrusion molding, and then covering the manufactured rubber tube over the metal base 312 (see FIG. 5). FIG. 5 is a cross-sectional view of the developer carrier 31 and FIG. 6 is an explanatory view illustrating positions of the developer carrier 31 and the magnetic sealing member 35.

The outer diameter of the developer carrier 31 of this Example is 11 mm, the diameter of the hollow metal base 312 is 10 mm, and the thickness of the rubber portion 311 is 0.5 mm. Although the rubber portion has a two-layer configuration and the rubber thickness is 0.5 mm in this Example, this configuration is not restrictive; any configuration may be employed as long as the rubber portion may be in stable contact with the photoconductive drum 1 and an electrostatic latent image may be developed.

Also in this Example, the relationship between the magnetic sealing member 35 and the rubber portion 311 of the developer carrier 31 along the longitudinal direction is the same as that in Example 1.

A position of a longitudinal direction end portion of the rubber portion 311 (a surface layer) of the developer carrier 31 is set to P2. A position of the inner end portion of the magnetic sealing member 35 is set to P1. A position of an outer end portion of the magnetic sealing member 35 is set to P3. Lengths from the center P0 of the development opening 301 to P1, P2 and P3 are set to L1, L2 and L3, respectively.

Here, since the relationship among L1, L2 and L3 is set to L1<L2≦L3, it is possible to successfully seal the toner and to reduce wear of the drum while reducing peeling of the rubber portion 311 of the developer carrier 31.

Positions of longitudinal direction end portions of the magnetic pole portions of the magnet roller 36 are disposed inside the position P3 of the outer end portion of the magnetic sealing member 35. If the longitudinal direction end portions of the magnetic pole portions of the magnet roller 36 are disposed outside the position P3 of the outer end portion of the magnetic sealing member 35, the magnetic force of the magnet roller 36 causes the toner T to be extracted outside the developer container 30, which is disadvantageous to the toner sealing. In this Example, the length from the center P0 of the development opening to the end portions of the magnetic pole portions of the magnet roller 36 is set to 111 mm.

In this Example, the contact developer supplying member employed in Example 1 is not provided, but the toner T is supplied using the magnet roller 36 as the developer supplying member included in the developer carrier 31. Since the contact developer supplying member rotates in the opposite direction to the developer supplying member to supply the toner T, frictional force which the developer carrier 31 receives is large. By using the magnetic force of the magnet roller 36 to supply the toner T to the developer carrier 31, this large frictional force does not exist and it becomes possible to fix the base 312 and the rubber portion 311 only by the sticking force.

Further, by using the magnetic sealing member 35 as the end portion sealing member, it is possible to fix the base 312 and the rubber portion 311 only by the sticking force. If a contact elastic sealing member is used, the developer carrier 31 receives large frictional force from the contact elastic sealing member. Naturally, since the developer carrier 31 receives the frictional force from the elastic sealing member only at a contact area, a difference in the frictional force may occur between the contact area and the non-contact area, which may cause twisting of the rubber portion 311.

Therefore, as in this Example, it is desirable to use the magnetic toner T and the magnetic sealing member 35 as the end portion sealing member. In this manner, even if the base 312 of the developer carrier 31 and the rubber portion 311 are fixed only by the sticking force, no twisting is caused in the base 312 and the rubber portion 311 and, therefore, a more inexpensive developing unit can be provided. Further, it is desirable that the toner T is supplied using the non-contact magnet roller 36.

As described above, in this Example, by using the magnetic toner T and the magnetic sealing member 35 as the end portion sealing member, even if the base 312 of the developer carrier 31 and the rubber portion 311 are fixed only by the sticking force, no twisting is caused in the base 312 and the rubber portion 311. Therefore, a more inexpensive developing unit can be provided.

Further, in the longitudinal direction, the end portion of the rubber portion 311 of the developer carrier 31 is disposed outside the inner end portion of the magnetic sealing member 35 and, at the same time, on or inside the outer end portion of the magnetic sealing member 35. That is, the end portion of the rubber portion 311 is disposed between the outer end portion and the inner end portion of the magnetic sealing member 35. Therefore, the following effects are provided. That is, a developing unit, a process cartridge in which this developing unit is used, and an image forming apparatus with which it is possible to successfully seal the toner and to reduce wear of the drum while preventing peeling of the rubber portion 311 of the developer carrier 31 can be provided. By reducing the wear of the drum, it is possible to provide a process cartridge and an image forming apparatus of prolonged lifetime in which the developing unit of this Example is used. Further, it is possible to provide a developing unit, a process cartridge and an image forming apparatus which are reduced in size in the longitudinal direction.

### ADVANTAGEOUS EFFECTS OF INVENTION

Finally, the effects of the configurations described above will be summarized as follows. That is, according to the developing unit, the process cartridge and the image forming apparatus of each of the Examples described above, it is possible to successfully seal the toner and to reduce wear of the image bearing member while reducing peeling of the elastic portion of the developer carrier.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-278517, filed Dec. 20, 2012 which is hereby incorporated by reference herein in its entirety.

What is claimed is:

1. A developing unit comprising:
a developer container configured to contain a magnetic developer;
a developer carrier provided with an elastic portion, configured to bear the magnetic developer in the elastic portion and to cause the elastic portion to be in contact with an image bearing member to develop a latent image formed on the image bearing member; and
a magnetic sealing member disposed, on a plane which perpendicularly crosses an axial line of the developer carrier, at a predetermined distance from a longitudinal direction end portion of the developer carrier and configured to regulate leakage of the developer from between the developer container and the developer carrier,
wherein,
in a longitudinal direction of the developer carrier, an end portion of the elastic portion is disposed between an inner end portion and an outer end portion of the magnetic sealing member.

2. The developing unit according to claim 1 wherein the developer carrier includes a base, and the elastic portion is a tube covered over a surface of the base and fixed to the base by elastic shrinking force.

3. The developing unit according to claim 1 further comprising a developer supplying member disposed inside the developer carrier and configured to supply the magnetic developer to the developer carrier by magnetic force.

4. The developing unit according to claim 3 wherein the developer supplying member is a magnet roller.

5. A process cartridge which is removably attached to a main body of an image forming apparatus, comprising:
an image bearing member;
a developer container configured to contain a magnetic developer;
a developer carrier provided with an elastic portion, configured to bear the magnetic developer in the elastic portion and to cause the elastic portion to be in contact with an image bearing member to develop a latent image formed on the image bearing member; and
a magnetic sealing member disposed, on a plane which perpendicularly crosses an axial line of the developer carrier, at a predetermined distance from a longitudinal direction end portion of the developer carrier and configured to regulate leakage of the developer from between the developer container and the developer carrier,
wherein,
in a longitudinal direction of the developer carrier, an end portion of the elastic portion is disposed between an inner end portion and an outer end portion of the magnetic sealing member.

6. The process cartridge according to claim 5 wherein the developer carrier includes a base, and the elastic portion is a tube covered over a surface of the base and fixed to the base by elastic shrinking force.

7. The process cartridge according to claim 5 further comprising a developer supplying member disposed inside the developer carrier and configured to supply the magnetic developer to the developer carrier by magnetic force.

8. The process cartridge according to claim 7 wherein the developer supplying member is a magnet roller.

9. An image forming apparatus for forming an image on a recording medium, comprising:
an image bearing member;
a developer container configured to contain a magnetic developer;
a developer carrier provided with an elastic portion, configured to bear the magnetic developer in the elastic portion and to cause the elastic portion to be in contact with an image bearing member to develop a latent image formed on the image bearing member; and
a magnetic sealing member disposed, on a plane which perpendicularly crosses an axial line of the developer carrier, at a predetermined distance from a longitudinal direction end portion of the developer carrier and configured to regulate leakage of the developer from between the developer container and the developer carrier,
wherein,
in a longitudinal direction of the developer carrier, an end portion of the elastic portion is disposed between an inner end portion and an outer end portion of the magnetic sealing member.

10. The image forming apparatus according to claim 9 wherein the developer carrier includes a base, and the elastic portion is a tube covered over a surface of the base and fixed to the base by elastic shrinking force.

11. The image forming apparatus according to claim 9 further comprising a developer supplying member disposed inside the developer carrier and configured to supply the magnetic developer to the developer carrier by magnetic force.

12. The image forming apparatus according to claim 11 wherein the developer supplying member is a magnet roller.
